(19) United States
(12) Patent Application Publication
(10) Pub. No.: US 2008/0030325 A1
(43) Pub. Date: Feb. 7, 2008

(54) RF-ACTIVATED TAG AND LOCATOR

(76) Inventor: ROBERT GORDON FRIES, Colorado Springs, CO (US)

Correspondence Address: ROBERT FRIES, 415 CAPRICE COURT, COLORADO SPRINGS, CO, 80921, US

(21) Appl. No.: 11/845,057

(22) Filed: Aug. 25, 2007

Related U.S. Application Data
(63) Continuation of application No. 11/756,617, filed on May 31, 2007.
(60) Provisional application No. 60/803,536, filed on May 31, 2006.

(51) Int. Cl. G08B 1/08

(52) U.S. Cl. 340/539.32

(57) ABSTRACT

An object locating system employing tags and a handheld locator. A unique low power tag circuit enables highly compact form factor and extremely long operating life even from the smallest available batteries. The tag employs an efficient passive RF energy detector circuit rather than an active receiver, as well as a novel low-power temperature-compensated biasing circuit to provide uniform sensitivity over a broad temperature range. The locator device transmits a tag activation signal, receives tag RF responses, and reports presence and optionally proximity changes to the user. An alternate tag design directly conveys proximity changes. The locator may also incorporate tag functionality to aid in finding a misplaced locator.

This application is a continuation of U.S. patent application Ser. No. 11/756,617, filed May 31, 2007, and claims the benefit of the prior Provisional application 60/803,536 filed on May 31, 2006.

### FIELD OF THE INVENTION

The present invention relates to the field of object locating systems in general, and to RF-based locator devices specifically.

### BACKGROUND OF THE INVENTION

There are many potential uses for a system which can indicate nearness to, and/or being in the presence of, a ‘tag’ which is attached to an object or a person. One use would be to identify an item uniquely out of a collection of items. Another use would be to locate lost items. There are a variety of item locating and identifying systems on the market. Tags which are activated by a radio frequency (RF) signal generally focus on maximizing the tag activation distance, along with employing an audible or visual response. Visual response mechanisms are obviously limited in usefulness if the object is not out in the open. Audible response mechanisms provide ease of use but are sometimes problematic as the sound can be dampened or blocked relatively easily. Audible response mechanisms also generally result in larger form factors for the tag.

In many cases it is desirable to have a tag device that is extremely compact. As such, the power source for the tag must also be extremely compact. Very small batteries, such as hearing aid or watch batteries, are available but have very low total energy storage. This necessitates that the tag circuitry must have extremely low power consumption when not activated (quiescent power consumption), so that the user would not be burdened with replacing batteries frequently.

Further, if the tagged object could be exposed to liquids or other environmental factors that would be detrimental to electronic circuitry, it would be best if the tag were completely sealed. This implies that the power source would not be replaceable, further demanding the lowest possible power consumption in the tag circuitry in order to ensure long usable life for the tag. When tag devices are designed for extremely high sensitivity so as to increase their activation range, they are more easily activated by extraneous signals, thereby reducing battery life and possibly increasing annoyance to the user.

What is needed in the industry is a tag-based proximity indicating system that uses a tag device whose design enables an extremely small form factor, low cost, long operating life, and inherent resistance to false triggering. Further, such a system should ideally be useable by those with hearing loss or poor eyesight.

### PRIOR ART

While most passive RFID tags operate as field-disturbance devices, some varieties of powered RFID tags employ similar operational mechanisms as the present invention, namely, being activated by the presence of an RF signal, and responding via a transmitted RF signal. However, RFID systems by their very nature must be able to retrieve a plurality of information contained within the tag; merely being in the vicinity of an RFID tag is of no importance to an RFID system, as the user must already know where the tagged object is in order to go and read it. RFID tag readers do not generally give indications of relative distance from the tagged object, since the value of an RFID tag is in the information it contains, not its relative location. The present invention, by contrast, makes use of the indication of presence and/or relative distance.

Another significant difference of the present invention from other prior art is that many locating systems provide only a singular response when a tag is activated, rather than varying the response so as to convey proximity information. Another significant difference from almost all of the prior art is that the present invention employs a passive RF energy detector, rather than an active RF receiver. Superhetrodyne, direct conversion and super-regenerative receivers all require substantial operating current. This implies large batteries, frequent battery replacement, and large form factor. The present invention also employs a more efficient detector stage than other similar prior art and draws substantially lower quiescent current, as well as other improvements.

Examples of patented devices which are related to the present invention include U.S. Pat. No. 6,734,795, U.S. Pat. Nos. 5,294,915 and 5,455,560 to Owen; U.S. Pat. No. 4,476,469 to Lander; U.S. Pat. No. 5,638,050 to Sacca; U.S. Pat. No. 5,337,041 to Friedman; U.S. Pat. No. 5,677,673 to Kipnis; U.S. Pat. No. 5,289,163 to Perez; U.S. Pat. No. 5,939,981 to Renney; U.S. Pat. No. 4,507,653 to Bayer; U.S. Pat. No. 4,101,873 to Anderson; U.S. Pat. Nos. 4,870,419 and 4,937,581 and 5,132,687 to Baldwin; U.S. Pat. No. 4,922,229 to Guenst; U.S. Pat. Nos. 5,164,732 and 5,196,846 to Brockelsby; U.S. Pat. No. 5,450,070 to Massar; U.S. Pat. No. 5,598,143 to Wentz; U.S. Pat. No. 5,629,677 to Staino; U.S. Pat. No. 6,011,466 to Goldman; U.S. Pat. Nos. 6,147,602 and 6,462,658 to Bender; U.S. Pat. No. 6,366,202 to Rosenthal; U.S. Pat. No. 6,535,125 to Trivett; U.S. Pat. No. 6,353,391 to Shearer; U.S. Pat. No. 6,573,832 to Fugere-Ramirez; U.S. Pat. No. 6,674,364 to Holbrook; U.S. Pat. No. 6,738,025 to Carrender. Patent applications related to the present invention include U.S. Pat. Application 20020017998, 20040036600, 20040113776, 20040217859, 20040246129, 20050088302, 20060007000, 20050231361, 20040075554, 20060028339, 20020036569, 20040017293, 20060109112, 20060077056, and 20050088302. Other related information may be referenced in the above material.

Other related reference material includes: LTC1540 data sheet, Linear Technology Corporation; Zero Bias Detector . . . Nanopower consumption, Linear Technology Magazine, February 1998; Application notes AN1089, AN956-4, AN963, AN988, Avago Technologies; HSMS-285X Datasheet, Avago Technologies.

### BRIEF SUMMARY OF THE INVENTION

The present invention's tag device is activated in response to an activation signal produced by the companion locator device. The activation signal could be modulated, unmodulated, single frequency, spread-spectrum and/or multiple radio frequencies. When the locator device is within range of a tag device, the tag's passive RF energy detector circuit(s) converts the ambient RF energy from the locator into one or more small output signal(s). The signal(s) is/are then buffered. The buffered signal(s) in turn activate(s) a response mechanism. If multiple separate-frequency energy detectors are used, all frequencies would need to be transmitted in order to activate the response mechanism, reducing false triggering. A single transmitter could hop between the frequencies, or multiple individual transmitters could be used. This approach, specifically the use of a passive RF detector rather than an active receiver, enables the construction of tag devices with extremely low quiescent power consumption. Tags can also be designed with moderate (rather than maximum) sensitivity in order to reduce false triggering, and this approach usually also yields lower quiescent current consumption.

To date, no RF-activated tag device has been produced that is compact enough to permit locating items such as eyeglasses while also providing extremely long battery life. One embodiment of the present invention yields a tag device which measures approximately 1.2″ in length and 0.190″ in width, including the battery. This is small enough to attach to a leg of a pair of eyeglasses without causing discomfort to the user or affecting the cosmetic appearance of the glasses, as the tag can be placed on the rear portion of the eyeglasses leg which is normally concealed behind the ear. This same form factor could be used with many other items, including keychains, wallets, sunglasses, luggage tags, coffee cups and cell phones, to name only a few.

The tag could be attached to an object by use of heat-shrinkable tubing, glue, adhesive tape or foam, a tag housing that employs an opening suitable for attachment to key rings, or other means, or could simply be contained within the object (such as a box or container). Other form factors are also possible, including incorporating the tag circuitry directly into products such as dentures, eyeglasses, sunglasses, wrist watches, laptop computers, remote controls, art objects, power tools or almost anything else of value. In battery-powered objects such as remote controls, if the tag is built into the object the tag circuitry could be powered from the object's available power source. Where a separate tag device is required, the tag would employ a power source.

When attached to eyeglasses with a metal support structure in the frame, the metal, though electrically isolated from the tag, usually acts as a supplementary antenna, increasing the activation sensitivity of the tag and potentially increasing the tag's RF response signal.

One tag embodiment typically consumes less than 100 nA of quiescent current. The SR416 (or type 377) watch battery is 4.8 mm×1.65 mm, roughly matching the width and height of the aforementioned tag's circuit board, and has a capacity rating of 8 mA-hours. Using this battery, the shelf life of this tag will be about 3 years if never activated, or would be about 2 years with 10 activations per month of 10 seconds each, or would be 2.5 years with 4 activations per month of 10 seconds each, assuming 4 mA activated current consumption. This permits the tag to be permanently sealed against environmental contaminants, as the tag can use a non-replaceable power source while still providing long operating life. Such sealing could be by means of an enclosure, a protective coating or other means. Further circuitry refinements may reduce the quiescent current even more and correspondingly increase the operating life. Other ways of increasing tag useful life could employ, for example, placing two such batteries in parallel, or using one or more larger-capacity batteries such as type 348 (which is also 4.8 mm diameter but thicker at 2.15 mm, and has an energy capacity of 12 mAh).

This exemplary tag device, with circuit characteristics described more fully in the Detailed Description, employs a receiving loop antenna implemented as a PCB trace; a dual zero-bias detector (ZBD) diode device connected in a dual half-wave detector configuration, with the ZBD's parasitic capacitance supplying the necessary capacitance to achieve resonance at 915 MHz; a transistor-based temperature compensated bias voltage generator; a series-diode supplemental temperature compensating means; a high-sensitivity digital buffer stage; a SAW-stabilized Colpitts one-transistor oscillator employing a PCB trace loop antenna, used as the response means; and a 1.55V type 377 hearing aid battery as its power source; in approximately a 0.190″ by 1.2″ form factor.

In one embodiment of the present invention, the tag's response mechanism is an RF transmitter that transmits on a different frequency than the tag's RF energy detector. This response signal from the tag may optionally be modulated, usually to convey information about the tag and/or the tagged object back to the locator. The locator would therefore employ a receiver circuit to ‘listen’ for the tag's transmitted response signal. If a tag is within range, the locator notifies the user of the tag's presence, and optionally indicates changes in the tag's proximity, by means of an audio signal, a visual indicator and/or a vibration source or other indication. The closer the locator is to the tag, the stronger the tag's response signal will usually be, and the indication(s) to the user may increase in intensity, duty cycle, cadence, pitch, frequency or any number of other characteristics. The locator could also employ a recorded voice to indicate relative proximity through words, or may use recordings of the user's own voice to identify the presence of specific tags or tagged objects.

A locator device may also contain tag circuitry so as to allow an inactive locator device to behave as a tag device, for the purposes of locating a misplaced locator device. The tag response functionality would be disabled if the locator device is presently in use as a locator, so as to not interfere with efforts to locate tagged objects.

One alternate embodiment of the present invention operates similarly, employing an audible response mechanism in the tag. This embodiment will typically be larger than the first embodiment due to including an audio transducer, and may use a higher operating voltage. This embodiment either presents a single audio response when activated, thus acting in a simple on/off manner, or varies its audio response in relation to the received signal strength of the activation signal by changing intensity, duty cycle, cadence, pitch, frequency or any number of other characteristics, thus providing a proximity indication. Such a tag could even use a recorded voice to indicate relative proximity through words.

Some or all of the tag's circuitry could further be embodied in a single package, such as a custom integrated circuit, a multi-chip module or other compact packaging means, without departing from the spirit of the invention.

### BRIEF DESCRIPTION OF THE DRAWINGS

FIG. 1 shows an overview of a locator device and a tag device that employs an RF response mechanism.

FIG. 2 shows an alternate embodiment of a tag system that employs a non-RF response mechanism.

FIGS. 3(a), 3(b) and 3(c) show example schematics of the tuned antenna portion of a passive RF energy detector circuit.

FIGS. 4(a), 4(b), 4(c), 4(d) and 4(e) show example schematics of several forms of detectors.

FIGS. 5(a), 5(b) and 5(c) show several possible embodiments of biasing circuits and high-sensitivity digital buffer partial circuit configurations.

FIG. 6 shows one embodiment of the tag's optional control logic.

FIG. 7 shows a block diagram of a locator that also has the functionality of a tag device.

### DETAILED DESCRIPTION OF THE INVENTION

A self-contained tag device could be sealed from the environment by an enclosure, a protective coating such as an epoxy dip, or other protective means, and would generally employ a power source. A tag device that is incorporated within or integrated into another object may use the power source of the object, if available, and the object's enclosure would provide protection for the tag circuitry.

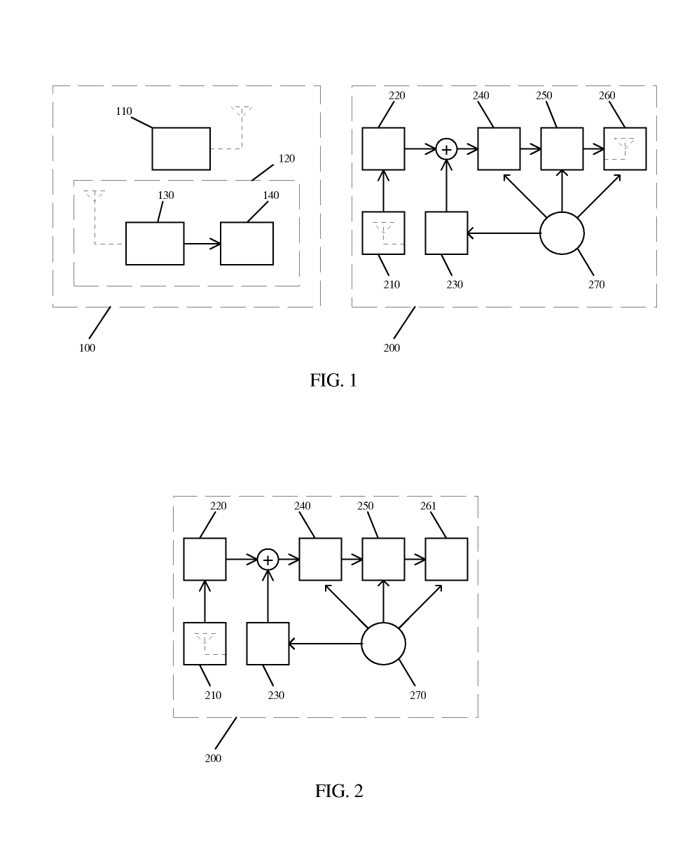

FIG. 1 shows one embodiment of a locator device (100) and a tag (200), where the tag (200) provides an RF response. The tag device (200) provides a tuned antenna (210) designed to resonate at a frequency generated by the transmitter (110) of the locator device (100). The signal transmitted by the locator's transmitter (110) would ideally be in an unlicensed frequency band such as 315 MHz, 433 MHz, 462 MHz, or 902-918 MHz. The tuned antenna (210) is coupled to a detector circuit (220) to provide an output signal. The detector's output is optionally summed with the output of an optional bias circuit (230) if such is present, and is then coupled to a high-sensitivity digital buffer circuit (240). The output of the high-sensitivity digital buffer circuit (240) is optionally coupled to control circuitry (250) which could examine the received signal and/or selectively control the activation and/or modulation of the response produced by the tag's response mechanism (260), which could be one of a variety of commonly known RF transmitter circuits such as a SAW-based or LC-based single-transistor Colpitts oscillator, or the output of the high-sensitivity digital buffer (240) may directly activate the tag's response mechanism (260).

In an alternate embodiment, more than one tuned antenna and detector may be employed to help guard against accidental activation by requiring that all detectors produce an output before the response means will be activated. It is also possible to employ only a single high-sensitivity digital buffer (240), where the output of one detector is used to trigger the activation of control circuitry (250), and the control circuitry then directly checks for the presence of a signal on the output of the additional detector(s), perhaps by use of an A/D converter or other sensitive means, before allowing the response mechanism (260) to be activated. The tuned antennae (210) would generally be designed for different frequencies. A power source (270) provides operating power for the bias circuit (230), the high-sensitivity digital buffer (240), the optional control circuitry (250), and the response mechanism (260). The tag device's (200) powered circuits have been designed to operate using a 1.5V power source (270) to permit an extremely compact form factor, but higher voltages could be used.

The locator device (100) provides a transmitter means (110) that is activated in order to attempt to activate tag devices (200) within its proximity. The transmitter (110) may employ a single transmitted frequency, multiple frequencies including spread spectrum and/or multiple transmitters, and may employ modulation, and may employ directional antennae to aid in determining the location of the desired object, and may employ multiple antennae to compensate for RF signal polarization. The locator (100) may automatically or manually cycle between multiple antennae, either on the transmitter (110) or receiver (130) or both, so as to avoid nulls and/or polarization in its radiation and/or detection patterns.

The locator device in this embodiment further provides a receiver subsystem (120) to receive the response from activated tag devices (200). The receiver subsystem (120) provides a receiver (130) capable of detecting the tag's RF response signal, and a user interface (140) to inform the user of the proximity of tag devices (200) and optionally other information pertinent to the operation and use of the system. The receiver (130) may employ directional antennae to aid in determining the location of the desired object, and may employ multiple antennae to compensate for RF signal polarization and/or to improve signal reception through the use of diversity and/or to create a directional antenna through phasing.

Typically modulation would be used by the locator (100) to cause activation only of tags matching a specific parameter or parameters, such as a certain category of tagged objects (eyeglasses, keys, remote control), or the owner's name, or other characteristic(s). As an example, On-Off Keyed (OOK) or Amplitude-Shift-Keyed (ASK) modulation may be employed.

The modulation of the activation signal could also be used to cause programming of certain parameters of a tag. Programmable parameters could consist of a unique serial number, a tag category (such as eyeglasses, remote control, car keys, etc), owner information (name, address), or any other information. Such programmed information may be presentd in the response, or may be used to limit the tag's response to only certain activation signal modulation patterns, or both, or may be used in other ways.

The locator device (100) may also provide a more extensive version of the user interface (140) that would allow the user to control or select the optional modulation characteristics. When turned on, the locator device may automatically manage the activation and deactivation of the transmitter (110) or may allow the user to control it manually. The RF signal strength of the activation signal may also be adjustable, either manually or automatically, permitting the user or the locator itself to control the activation distance as needed to aid in the user's search. Lower transmitter power reduces the activation distance, and therefore narrows the search scope.

Alternately, the locator's transmitter signal may be unmodulated, but the tag's response may still be modulated, one purpose for such being to convey information about the tag and/or the tagged object. In this case, the locator device (100) would need to be able to interpret the modulation and would likely provide a user interface (140) capable of presenting information to the user about the tag or tagged object, based on the information received from the tag (200).

If a tag (201) provides a response means that is directly discernable by the user such as an audible tone, there may be no need for the tag to provide an RF response. In such cases, the tag can optionally be designed for maximum sensitivity to allow maximum activation distance. The tag may optionally provide a varying response to indicate changes in proximity relative to the locator, typically detecting this through the received activation signal strength, or may provide only a single response regardless of proximity.

If the tag (200, 201) does provide an RF response, then a corresponding receiver (130) must be available in the system. The locator's receiver (130) ‘listens’ for a response from a tag device (200, 201) and indicates this to the user through a user interface (140). The receiver (130) or user interface (140) may optionally examine the received signal for signal strength (typically by means of through an RSSI signal or equivalent) and/or modulation of coded information, providing such to the user to aid in his search. This information could consist of a description of the device type, a globally unique serial number for the tag, the owner's name or address, a relative indication of received signal strength, or potentially any other information. The locator device (100) would typically employ a microcontroller but a simple locator could be constructed without one. A receiver (130) may be constructed in a variety of ways commonly known in the industry, including the use of single-chip keyfob receivers.

The feedback to the user through the user interface (140) could be in the form of a visual indication (as simple as a single LED, or more complex such as an LCD display), an audible indication from a transducer, a vibration, or other means. Through variations of wording, intensity, cadence or other parameters, the user may be informed of both presence and changes in relative proximity to a tag by using, for example, the strength of the received signal from the tag. For example, an audio chirp could increase in volume and/or pitch and/or speed as the user gets closer to a tag.

By employing a directional antenna in the receiver (130), the user will more easily be able to determine the location of a tag (200). A variety of commonly known directional antenna designs exist and could be employed for this purpose. The use of diversity and/or multiple antennae in the receiver system (130) to reduce nulls and polarization may also be employed.

The receiver (130) and user interface (140) may also be constructed as a separate subsystem that could be attached to an off-the-shelf transmitter (110) or transceiver device. The subsystem could employ and be activated by circuitry similar to that of a tag device (200), typically including the tuned antenna (210), the detector (220) and the high-sensitivity digital buffer (240). In this case, activation of the locator transmitter (110) would automatically turn on the receiver (130) and user interface (140), eliminating the need for the user to turn on/off both the transmitter (110) and said subsystem. One embodiment of such a subsystem is only 1″ square, including its battery.

FIG. 2 shows an alternate embodiment of the tag (201) that is similar to the tag (200) in FIG. 1, except that an alternate response mechanism (261) is employed. This alternate response mechanism will likely force a change of form factor and may also require a higher voltage power source (270). If the response mechanism (261) is directly detectable by the user, such as a visible or audible indication, then the locator (100) may not require a receiver subsystem (120), although it can be present without detriment to the system's operation. More than one means may be employed in the response mechanism (261), for example an audio transducer, a light source and an RF transmitter.

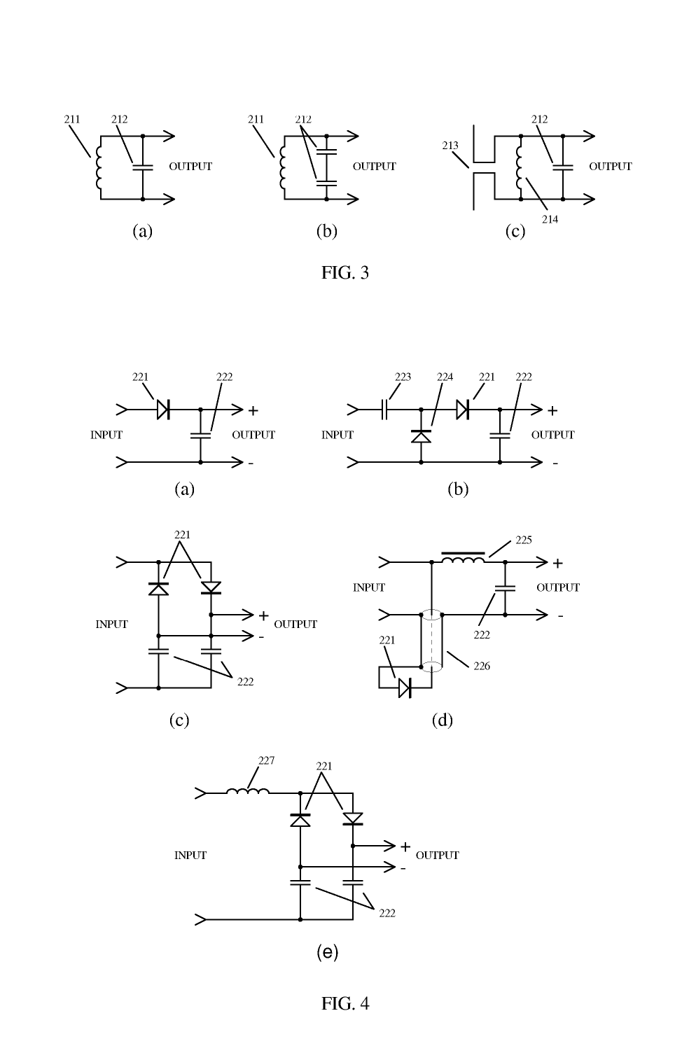

FIG. 3 details some possible embodiments of the tuned antenna of a passive RF energy detector circuit. In FIG. 3(a), an inductor (211) that also functions as a loop antenna may be constructed using a printed circuit board wiring trace. This may consist of a partial loop, a single loop or multiple loops. Alternately a separate component, rather than a PCB trace, may be used. A capacitor (212) is used in conjunction with the inductor (211) to form a resonant circuit. The capacitor (212) may be a single device, or may be two or more devices in series (as shown in FIG. 3(b)) and/or parallel to achieve the desired capacitance value, and generally includes the parasitic capacitance of other components, including but not limited to the PCB. In certain cases, the parasitic capacitance of the circuit may suffice by itself. The series method of FIG. 3(b) is especially helpful when the required capacitance value is small, perhaps less than 10 pF, because parasitic effects of the circuit become more predominant at that level, perhaps even exceeding the value of the capacitor (212). As shown in FIG. 3(c), a dipole antenna configuration (213) could be used along with an inductor (214) and capacitor (212). Other forms of antennae and RF resonant circuits could also be used and are to be considered as being within the scope of the invention. The output of the resonant circuit is an AC signal which includes all RF signals of significant amplitude within the resonant frequency range of the resonant circuit.

FIG. 4 details several configurations of detector circuits. Any type of rectifying element could be used, including but not limited to silicon or germanium semiconductor junctions from diodes or transistors, as well as specialty devices. Zero Bias Detectors (ZBDs) are a special form of Schottky rectifier that is useful in this application, although standard Schottky rectifiers also work but generally require more RF energy to be present before they produce an output. It is also possible to provide a biasing current to increase the sensitivity of standard Schottky rectifiers, small signal diodes, transistors or other rectifiers.

FIG. 4(a) shows a standard half-wave configuration of the detector (220). The rectifying element (221) allows only the positive portion of the signal from the resonant circuit (210) to charge the storage capacitor (222).

FIG. 4(b) shows a voltage doubler configuration of the detector (220). Isolation is provided by capacitor (223), which is charged to a DC voltage during one half of the AC cycle by means of the second rectifying element (224). Charge is then transferred from the isolation capacitor (223) to the storage capacitor (222) through the first rectifying element (221) on the opposite side of the AC cycle. Commonly known voltage tripling or voltage quadrupling circuits could also be employed.

FIG. 4(c) shows a dual half-wave configuration, where both outputs are summed (added). It is configured as two half-wave detectors (221, 222) operating with opposite polarity. The circuit configuration places the two storage capacitors (222) effectively in series, adding their voltages together. In practice, this configuration appears to produce a significantly higher output than the voltage doubler configuration (such as that shown in FIG. 4(b)) for a weak input signal when using ZBD rectifiers.

FIG. 4(d) is an alternate form of detector that utilizes an impedance matching circuit element, in this case a transmission line (226), to maximize the energy transfer from the resonant antenna circuit (210) to the detector (220). The matching transmission line (226) is used to cancel the impedance of the rectifying element, and its optimum length is dependent on the specific rectifying device used and the frequency being detected. The transmission line may be constructed using microstrip circuit traces, coaxial cable or other methods.

FIG. 4(e) shows an example of the use of an impedance matching circuit element to improve energy transfer. An inductor (227) is added to the detector circuit of FIG. 4(c) to transform the impedance of the detector (220) to more closely match the impedance of the resonant antenna circuit (210), maximizing the energy transfer and thereby increasing the sensitivity of the detector (220).

Any or all of the above methods may be combined to provide even higher signal output from the detector circuit. Other forms of impedance matching, such as the use of inductors, transformers, capacitors, resistors, transmission lines and/or microstrip or stripline elements, as well as other detecting means or combinations of detecting means such as biased detectors, may also be used and are to be considered as being within the scope of the present invention.

FIG. 5(a) details one embodiment of a temperature compensating bias circuit (230) that is used in conjunction with a bipolar transistor based, low quiescent current, high-sensitivity digital buffer (240). The turn-on threshold voltage of a bipolar junction transistor is usually hundreds of millivolts and is also highly dependent on temperature. Although a very strong activation signal of a few hundred millivolts could directly feed the input transistor (241) without needing biasing, this is not always practical due to limitations on transmit power imposed by the FCC for most frequencies. When using a high-sensitivity digital buffer that employs a simple bipolar transistor input stage, a temperature-compensated bias circuit could be added in order to reduce the required transmit power while also maintaining a relatively uniform tag activation sensitivity over a wide temperature range. Temperature-dependent elements could be utilized in both the bias circuit (230) as well as the high-sensitivity digital buffer (240) as needed.

One type of temperature-compensating bias voltage generator, as shown in FIG. 5(a), can be constructed using a transistor (231) of the same or similar type as the transistor (241) used as the input stage of the high-sensitivity digital buffer (240). The bias generator's operating current is established by a resistor (232) whose value would typically be in the 20 MegOhm range, assuming a supply voltage of approximately 1.5V. This current turns the bias-generator transistor (231) slightly on, causing collector current to flow through the second resistor (233), which is typically in the range of 100 to 250 Kohms. The two resistors (232, 233) thereby form a voltage divider, allowing very precise control over the voltage drop across the second resistor (233). This voltage drop can be set so that the bias generator's (230) output voltage, taken from the collector of the bias-generator transistor (231), is maintained at the point where the high-sensitivity digital buffer input transistor (241) is very slightly on, but below the point where the second buffer transistor (243) would begin to turn on, thus ensuring that the output of the high-sensitivity digital buffer (240) remains off across a wide range of operating conditions. This bias generator (230) tracks ambient temperature changes, and thereby improves overall tag sensitivity by allowing the bias voltage to be set closer to the turn-on threshold voltage of the high-sensitivity digital buffer (240) than if a simple voltage divider bias circuit were used.

The output of the bias circuit (230) is summed with the output of the detector circuit (220) by being connected in series with it, and the output of the detector circuit (220) is approximately zero when not in the presence of a suitable RF activation signal. The base resistor (242), typically in the range of 10 Mohm, ensures that weak conduction or leakage current from the input transistor (241) does not unintentionally turn on the second transistor (243). When an appropriate RF activation signal is present, the output of the detector circuit (220) is added to that of the bias circuit (230), pushing the high-sensitivity digital buffer's (240) input transistor (241) further into conduction, resulting in a flow of additional collector current. The voltage at the base of the second transistor (243) therefore increases, turning both it and any subsequent buffer stages on.

While this version of the circuit dramatically improves the uniformity of the sensitivity of the tag over temperature when compared to a simple resistor divider, the increased leakage of semiconductors at high temperatures will cause the transistor (241), and hence the high-sensitivity digital buffer (240), to produce an output at high temperatures even when no RF energy is present. Further reducing the bias generator's output voltage eliminates this effect, but at the expense of lowered sensitivity at room temperature.

An improved version of a temperature-compensated bias generator is shown in FIG. 5(b). The bias generator (230) is similar to that described in FIG. 5(a) with an additional temperature-dependent adjusting means provided. Two generic small-signal diodes (236) of type 1N914 or similar, and a current-limiting resistance (237) in the range of 5.1 Mohms, are all connected in series and are placed across the base-emitter junction of the high-sensitivity digital buffer's (240) input transistor (241). These devices (236, 237) shunt current away from the base-emitter junction of the transistor (241), hence reducing the base-emitter voltage and tightly controlling the turn-on threshold, and they do so in a varying amount that is also affected by temperature. The resulting overall tag circuit remains ‘off’ at temperatures beyond 60° C. while also further reducing the variance in sensitivity to less than 10 mV. Overall sensitivity is minimally affected by the specific beta of the transistors (231, 241) used. Specific component values for resistors (232, 233, 237) are dependent on the specific transistors (231, 241) and diodes (236) chosen and affect each other. Maximum sensitivity is achieved when the input transistor (241) is slightly turned on, and the resulting voltage drop across the resistor (242) is maintained just below the turn-on threshold of the second transistor (243). This configuration allows a higher upper temperature limit before the high-sensitivity digital buffer turns itself on without an RF activation signal.

As one possible further enhancement, a thermistor could be added to or substituted for the bias-generator transistor's (231) collector resistor (233) to even further extend the upper temperature limit and possibly to further improve the uniformity of the sensitivity of the overall circuit. A thermistor could also be employed in conjunction with or instead of the base resistor (242) to decrease the resistance at higher temperatures. Other forms of bias generators may utilize thermistors in other ways, or may employ other temperature-dependent components and/or configurations, and should also be considered to be within the scope of the present invention.

Other forms of high-sensitivity digital buffers may also be used, some of which may not require a temperature-compensated bias circuit. A simpler biasing circuit which is not temperature compensated could be constructed using only a voltage divider, as in FIG. 5(c). Two resistors (234, 235) form a reference voltage that is slightly above GROUND, setting the threshold of sensitivity. When the output of the detector circuit (220) is higher than the reference voltage, the output of the differential-input amplifier (249) (typically an op-amp or a comparator) changes to a positive voltage. The use of a voltage reference circuit to provide a highly stable bias voltage could be used but would not generally be required, as the output of most hearing aid or wristwatch batteries is quite constant over the useful life of the battery. However, integrated-circuit differential-input amplifiers that operate on low voltages (1.5V), have power consumption in the nanoamp range, and have extremely low offset voltage (such as less than 1 mV) over a wide temperature range do not yet exist, therefore compromises in the design, such as using a higher operating voltage and drawing more quiescent current, will be required to utilize existing devices.

The above describes only a few of the possible circuits which could be employed to yield an appropriate high-sensitivity digital buffer circuit; all other variations should be considered to fall within the scope of the present invention. For instance, low-threshold MOSFET devices are now becoming available, and these devices could be used for all or part of the high-sensitivity digital buffer circuit (240), but they are presently expensive by comparison. JFETs or other semiconductors could also be used. In general, integrated circuits suitable for use in this application that will operate on extremely low current and at 1.5 volts are not presently available, but could become available in the future; alternatively, a custom IC may be designed to suit this purpose.

The output of the detector (220) could also directly drive the input of an unbiased high-sensitivity digital buffer circuit (240). This could reduce the quiescent operating current of the tag to an extremely low value, perhaps even as low as a few nanoamps (essentially the leakage current of the tag's circuitry), but may require a relatively strong activation signal, depending on the specific design of the high-sensitivity digital buffer.

The output of the high-sensitivity digital buffer circuit (240) either directly activates the tag's response mechanism(s) (260, 261), or triggers optional control circuitry (250). This control circuitry (250) may analyze the received signal so as to determine whether or not to respond, or may modulate the response, or both. Typically the control circuitry will utilize a microcontroller, but analog circuitry alone may suffice for either or both functions, including but not limited to using a PLL to listen for a particular modulated tone frequency on the received activation signal, or having the response signal be modulated by means of a simple oscillator.

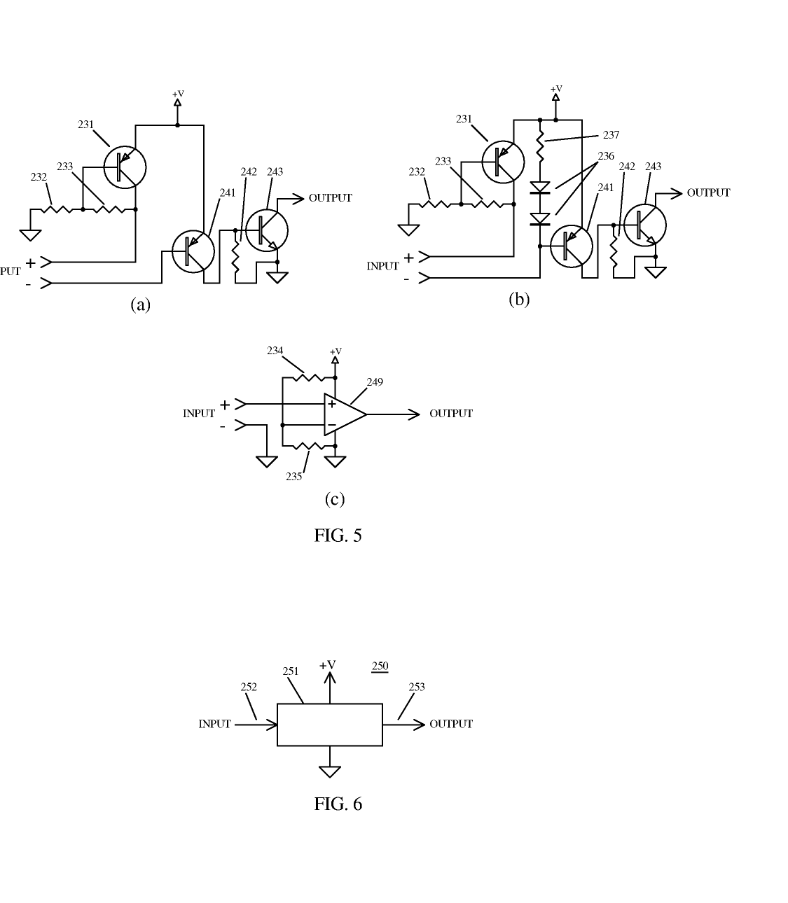

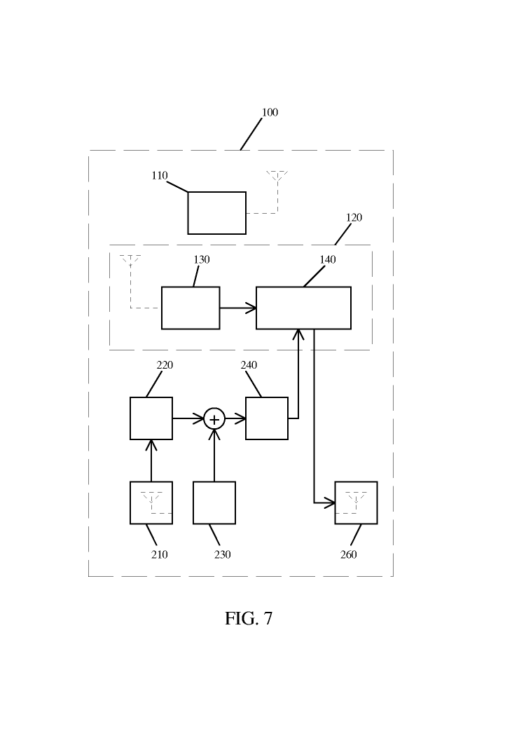

FIG. 6 shows one embodiment of the use of a microcontroller (251) as the control circuitry (250). The microcontroller (251) is configured to awaken from a low-power sleep mode upon detecting a change on its input (252), which is fed from the high-sensitivity digital buffer's (240) output signal. This input signal (252) can also be monitored as a digital and/or analog input by the microcontroller (251). The microcontroller (251) is thereafter able to control its own return to sleep mode, regardless of the presence or absence of an activation signal at its input (252). Thus, the microcontroller (251) could observe the received signal over a period of time to check for certain required characteristics to be present before activating the response mechanism, such as one or more tones in the baseband signal, or perhaps an encoded signal such as OOK. The microcontroller (251) could alternately or additionally perform modulation of the response mechanism(s) by means of its output signal (253), such as responding with a particular modulation tone frequency or a coded signal. Many modern microcontrollers provide internal power management and clock circuitry, so the only extra connections required are power and ground. Some microcontrollers provide analog comparators, thus the microcontroller (251) may be able to integrate the high-sensitivity digital buffer (240) functionality, further simplifying the circuitry. Additionally, a microcontroller (251) incorporating an A/D converter could use an A/D input to monitor the received signal strength by directly monitoring either the output of the detector stage (220) or possibly an intermediate stage inside the high-sensitivity digital buffer (230), and could use this information in controlling the response mechanism (260, 261).

The microcontroller (251) could also monitor the received activation signal for a special pattern that is used to initiate a programming mode, where specific and customizable information is conveyed to the tag. Because the tag can operate for extended periods without requiring a replacement of the power source, such programmed information, which would normally require nonvolatile storage, may optionally be held in volatile storage (such as static RAM) since the device potentially might never be powered off. The locator (100) could provide the ability to be used as a tag ‘programmer’ in addition to its main function of being a tag ‘locator’. It is also possible to restrict locators (100) to only being able to ‘program’ limited information, while at the factory additional information (such as a unique serial number) could be programmed that would not be modifiable by the user.

In one embodiment of the present invention, the tag (200) responds to an activation signal from a locator device (100) by transmitting an RF signal back to the locator device (100) on a different frequency than the activation signal. In an alternate embodiment, the tag (200) could respond on the same frequency, possibly only after the activation signal stops, and would transmit for a limited time. Thus, a user could momentarily activate the locator's (100) transmitter, then deactivate it (or it could automatically deactivate itself) and check for a response from tag devices (200). In this case, the tag (200) would likely detect its own transmitter (260) output, and would thereby lock itself on because of that feedback. By using a microcontroller (251) or other circuitry, this feedback could be interrupted so as to allow the tag (200) to turn off after transmitting for a few seconds or so.

Tags that have the ability to selectively respond to a modulated activation signal could be configured to activate not only when they detect a properly modulated activation signal, but could additionally activate if the activation signal is unmodulated. In this way, even a simple unmodulated locator device could still be used with these enhanced-capability tags. When a modulated activation signal is present, the tags would respond selectively; when an unmodulated activation signal is present, all tags within range would respond. Likewise, a locator device that is capable of modulation could be constructed so as to be capable of transmitting one or more unmodulated signals; this modulation choice could be part of an automatic behavior, or could be controllable by the user.

FIG. 7 shows one embodiment of a locator device (100) that additionally incorporates tag functionality. A tuned antenna circuit (210), an energy detector circuit (220), a bias circuit (230), and a high-sensitivity digital buffer circuit (240) have been added to the locator device (100). The output of the high-sensitivity digital buffer (240) is coupled to the locator's user interface (140) so that when the locator (100) is not in use, the locator's user interface (140), preferably using an audio transducer, will be activated in response to an activation signal that is sent from another locator device. An alternate embodiment could employ an RF transmitter (260) and/or control logic, and/or could make use of the logic available within the user interface (140) to provide selective response control and/or modulation of that RF response. The locator's tag functionality might have provision to be disabled by the user so as to not interfere with a nearby search for a tagged item, but it would be advantageous if the locator automatically re-enabled its tag functionality after a period of time so that its tag functionality would operate as expected later, even if the user forgot to re-enable the tag functionality.

It will be appreciated by those of ordinary skill in the art that this invention can be embodied in various specific forms without departing from its essential characteristics. The disclosed embodiments are considered in all respects to be illustrative and not restrictive. The scope of the invention is indicated by the appended claims, rather than the foregoing description, and all changes that come within the meaning and range of equivalents thereof are intended to be embraced thereby.

I claim:

1. A locating system, comprising:
(a) at least one tag device comprising:
(1) at least one passive RF energy detector means;
(2) at least one low-quiescent-power signal buffer means operatively coupled to said RF energy detector means; and
(3) at least one response means; and,
(b) at least one locator device comprising:
(1) an RF transmitter means suitable for activating said tag device;
(2) at least one antenna means coupled to said RF transmitter means; and
(3) at least one power source;
and where said system further comprises at least one relative proximity assessing means and at least one indicating means, and where said tag device is capable of being activated remotely by said locator device using an RF activation signal.

2. The system of claim 1, where said passive RF energy detector means comprises at least one rectifying element, configured in at least one member of the group of half-wave, dual half-wave, full-wave, voltage-doubler, voltage-tripler, and voltage-quadrupler configuration(s).

3. The system of claim 1, where said tag device further comprises low-power temperature compensation means.

4. The system of claim 1, where said tag device is reasonably sealed against environmental contaminants.

5. The system of claim 1, where said buffer means is operatively coupled to said response means.

6. The system of claim 1, where said tag device further comprises control circuitry means, said circuitry being operatively coupled to said buffer means and said response means, and where said control circuitry means comprises at least one member of the group of:
(a) the ability to selectively control activation of said tag's response means in reaction to characteristics of said activation signal;
(b) the ability to selectively control operation of said tag's response means in reaction to the passing of time; and
(c) the ability to modulate said tag's response means so as to convey a plurality of information.

7. The system of claim 6, where said control circuitry means is programmable.

8. The system of claim 1, where said tag device further comprises a means of assessing relative proximity of said tag device to said locator device.

9. The system of claim 8, where at least one of said tag device response means comprises a means directly detectable by a human, and where said response means is capable of providing a variable output that is capable of indicating variations of proximity relative to said locator device.

10. The system of claim 1, where the transmitter power of said locator device's RF transmitter means is variable.

11. The system of claim 1, where said transmitter of said locator device further comprises at least one directional antenna.

12. The system of claim 1, where said tag response means comprises an RF transmitter means, and where said locator device further comprises a receiver means capable of receiving said tag device's RF transmitter means, and where said receiver further comprises at least one antenna.

13. The system of claim 12, where said antenna is directional.

14. The system of claim 1, where said locator device further comprises at least one means of indicating relative proximity of at least one tag device to users of said locator device.

15. The system of claim 1, where said locator device further comprises the functionality of said tag device.

16. The system of claim 1, where said tag device is able to operate from a 1.55V or lower power source means.

17. The system of claim 1, where the current drawn by said tag device, when said tag device is not activated, is less than 1 microamp for all temperatures in the range of −20 to +60 degrees Celsius.

18. The system of claim 1, where said tag device functionality comprises at least one member of the group of: (a) being enclosed within another object while operating independently of said object; and (b) being integrated into another object.

19. The system of claim 1, where said transmitter's instantaneous RF output power exceeds the mandated allowable continuous-mode RF radiation limits for the transmitter's operating frequency, and further where said transmitter's output is duty-cycled such that the average transmitter output power is at or below allowable RF radiation limits for pulsed transmitters.

20. The system of claim 1, where at least one of said tag response means comprises an RF transmitter, and where said tag response transmitter's instantaneous output power exceeds the mandated allowable continuous-mode RF radiation limits for the tag response transmitter's operating frequency, and further where said tag response transmitter's output is duty-cycled such that the tag response transmitter's average output power is at or below allowable RF radiation limits for pulsed transmitters.
